(19) United States
(12) Patent Application Publication
(10) Pub. No.: US 2017/0262880 A1
(43) Pub. Date: Sep. 14, 2017

(54) PROXIMITY DETECTION SYSTEM AND METHOD

(71) Applicant: C-4 Analytics, LLC, Saugus, MA (US)

(72) Inventor: Justin Cook, Swampscott, MA (US)

(21) Appl. No.: 15/066,528

(22) Filed: Mar. 10, 2016

(51) Int. Cl. G06Q 30/02; H04W 4/02

(52) U.S. Cl. CPC G06Q 30/0246; H04W 4/023; H04W 4/028

(57) ABSTRACT

Systems and methods for detecting a physical presence of a device previously used to view electronic records are herein disclosed as comprising, in an implementation, a detector and a computing system, the detector being configured to detect a physical presence of a first device in proximity to the sensor and to establish, without intervention, communication with the first device upon detection, and the computing system being configured to receive an identifier and browsing data communicated by the first device and identify data indicative of a prior communication of the electronic record to at least one of the first device and a second device.

### TECHNICAL FIELD

The present disclosure relates to systems and methods for detecting a physical presence of devices previously used to view electronic records.

### BACKGROUND

Advances in computing technology have made it commonplace for mobile devices to access the Internet and view or otherwise interact with online electronic data. Commercial entities are able to reach past and prospective customers using new media for attracting attention, such as offering interactive games or videos on their websites or by placing advertisements on various third-party websites targeted to those customers. Data indicative of a person's online viewing records and interactions can be used to provide meaningful suggestions for other websites to browse or goods to purchase through online vendors. However, this Internet-centric data has offline application, as well.

### SUMMARY

Disclosed herein are aspects of systems and methods for detecting a physical presence of a device previously used to view electronic records. One aspect of the disclosure is a proximity detection system for detecting a physical presence of a device previously used to view an electronic record, comprising a detector comprising a processor and a sensor coupled to the processor, the detector configured to detect a physical presence of a first device in proximity to the sensor, wherein the first device is associated with a user, and to establish, without intervention, communication with the first device upon detection, and a computing system in communication with the detector, the computing system configured to receive an identifier and browsing data communicated by the first device and identify data indicative of a prior communication of the electronic record to at least one of the first device and a second device.

Another aspect of the disclosure is a method for detecting a physical presence of a device previously used to view an electronic record, comprising detecting, by a sensor, a first device in proximity to the sensor, the first device having an identifier associated therewith, initiating communication between the first device and a network associated with the sensor, determining, by a computing system operable on the network, an electronic record previously communicated to one of the first device and a second device, and identifying a commercial activity performed in proximity to the sensor by a user associated with the first device.

Another aspect of the disclosure is a computer program product implemented on a non-transitory storage medium for an intelligence dashboard configured to monitor and analyze data indicative of communications of electronic records comprising a program module having instructions configured to identify browsing data communicated by one of a first device to which an identifier is associated and a second device associated with the first device, identify in-store data based on the identifier, generate intelligence data based on the browsing data and the in-store data, and analyze an efficacy of one or more online advertisements based on the intelligence data.

Details of these implementations, modifications of these implementations and additional implementations are described below.

### BRIEF DESCRIPTION OF THE DRAWINGS

The description herein makes reference to the accompanying drawings, where like reference numerals refer to like parts throughout the several views, and where:

FIG. 1 is a block diagram of an example computing network usable within implementations of the present disclosure;

FIG. 2 is a perspective view of a storage enclosure for housing computing equipment usable within implementations of the present disclosure;

FIG. 3 is a block diagram of a digital data processing machine usable within implementations of the present disclosure;

FIG. 4 is a diagram showing data being communicated between an example user device and an example proximity detection system;

FIG. 5 is a diagram of example data associated with an example user device usable within implementations of the present disclosure;

FIG. 6 is a block diagram of an example intelligence dashboard usable within implementations of the present disclosure; and

FIG. 7 is a flowchart showing an example method for using an implementation of the present disclosure for detecting a physical presence of a device used to view an electronic record.

### DETAILED DESCRIPTION

Data indicative of a person's online viewership and interactions with electronic records provide useful insight to his or her interests. In the context of online advertising, there are significant difficulties associated with effectively correlating online advertising viewership or interaction with offline shopping activity. For example, although a commercial entity may easily be able to monitor and identify is customers' online habits, for example, by tracking viewing and interaction with online advertisements or websites associated with the commercial entity, in a physical store context, it generally must rely upon a customer identifying an online advertisement as a reason or basis for his or her offline traffic. Even where the customer is capable of accurately describing online advertising or website viewership, manual data entry must be done for each customer to properly identify trends in online advertisements for offline attribution. Further, the effectiveness of an online advertisement campaign cannot be properly measured where data indicative of an Internet user's viewership of online content associated with the commercial entity is not correlated.

One solution for measuring the effectiveness of online advertising includes associating unique identifiers with Internet users and monitoring online advertisement viewership and interaction based on those identifiers. After an Internet user travels to a physical store associated with the online advertisements and makes an offline purchase, data indicative of the purchase may eventually be associated with the user's unique identifier. This information can be analyzed well after a transaction is completed to assess whether the online advertisements may have had an effect on facilitating the offline purchase. Still, this solution does not include any way to identify retail store customers who have previously viewed online advertisements or websites related to a commercial entity while those customers are still in the retail store. For example, it would be highly desirable to identify customers present in or near a retail store who have not yet completed a transaction and who have previously viewed an online advertisement associated with the commercial entity or the goods sold thereby prior to entering the store. Identifying these customers early in a shopping experience may provide ample opportunity for the commercial entity to increase sales made to them, for example, by focusing on or expanding from topics of interest identified by their online viewership and interactions.

Implementations of the present disclosure include systems and methods for detecting a device used for viewing electronic records within a near proximity of a physical location. Data indicative of viewership and/or interaction with electronic records, such as online advertisements associated with a commercial entity, can be identified from a user device detected over a network or other communication system. The proximity of the user device with respect to a physical location, such as a bricks-and-mortar retail store, associated with the commercial entity can be detected along with a duration of time that the proximity of the user device was so detected. This data can be correlated immediately upon detection or within a nearly immediate time thereafter to determine a user of the user device's exposure to the electronic records. Data indicative of the proximity of the user device with respect to the physical location and the duration of the proximity may be correlated with sales to identify attributions for online advertising impressions based on offline customer traffic and/or sales in the physical location.

The present disclosure is not limited to maintaining an ongoing relationship with a single consumer. Rather, it instead can identify a lead presented in a physical location, such as a physical store, for the purpose of completing a single transaction, regardless of the identity of the particular customer. Implementations of the present disclosure do not necessarily rely upon special sales, limited time offers, etc., for identifying leads, as data indicative of a lead can be derived from a user device detected within a near proximity of the physical store.

The systems and methods of the present disclosure address problems particular to the Internet, for example, those concerning attribution of offline customer traffic and sales to online advertising viewership or interaction. These Internet-specific issues can be solved by implementations of the present disclosure. For example, the aforesaid attribution can be facilitated by detecting devices associated with customer viewership and interaction. The development of new ways to present online advertisements is fundamentally related to the Internet; however, the nature of online advertising renders offline attribution difficult, as information about a customer in a physical store's online viewership and interaction records are not apparent to the commercial entity. Implementations of the present disclosure can provide a way to efficiently attribute online advertisement viewership and interaction by identifying electronic record data associated with user devices detected within a near proximity of a physical store.

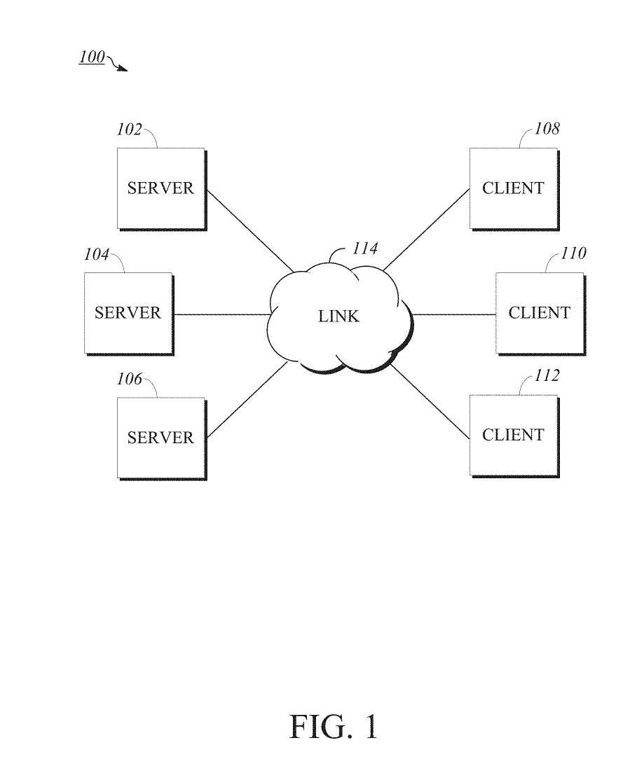

To describe some implementations in greater detail, reference is first made to examples of hardware structures and interconnections usable with implementations of the present disclosure. FIG. 1 is a block diagram of an example computing network 100. Computing network 100 includes various computer resources including servers 102, 104, 106 and client computers 108, 110, 112 (also referred to as clients) interconnected to computing network 100 and each other via telecommunications link 114. One example of link 114 is the public Internet, and other examples include multiple local area networks, wide area networks, Intranets, Extranets, Internetworks, Wi-Fi networks, or any other suitable technology using wires, radiofrequency, microwave, satellite, cellular, optical, or other telecommunications systems. Computing network 100 includes digital data storage, which may be represented by one or more of servers 102, 104, 106. Examples of the hardware components and interconnections of servers 102, 104, 106, clients 108, 110, 112, and various data storage are discussed in detail below. In an implementation, servers 102, 104, 106 store and manage client data. Client data may be stored in a single site, location, or device. Alternatively, client data may be distributed among different sites, locations, or devices.

Servers 102, 104, 106 can be computers on which a website or portions of a website (e.g., content, advertisements, etc.) are located. In an implementation, servers 102, 104, 106 can be application layers of servers for loading instances of websites or portions of website. Clients 108, 110, 112 can be computers on which the website or portions of the website are viewed, for example, by navigating an Internet browser to a web address. In an implementation, clients 108, 110, 112 are mobile devices, such as smart phones, tablets, laptop computers, personal digital assistants, handheld gaming devices, etc. In an implementation, clients 108, 110, 112 are non-mobile devices, such as desktop computers, server computers, non-handheld gaming devices, printers, scanners, etc. In an implementation, link 114 includes communication between the servers of computing network 100 (e.g., between servers 102, 104, 106) and/or between the clients of computing network 100 (e.g., between clients 108, 110, 112).

In an implementation, computing network 100 may be applied to the task of cloud computing. Cloud computing may provide various advantages over traditional computing models, including the ability to allocate shared resources amongst many different customers. Under traditional computing models, computing resources are typically allocated to a single customer or entity and substantial portions of those resources may remain unused or underused.

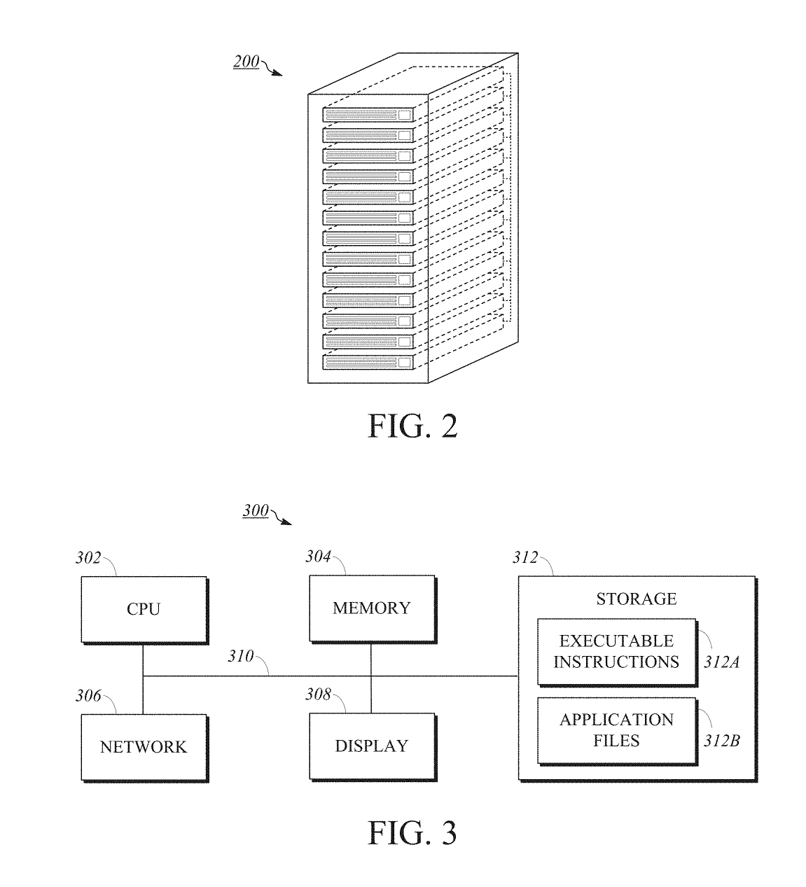

The data processing components of this disclosure, including the computing network of FIG. 1, may be implemented by various hardware devices. The makeup of these subcomponents is described in greater detail below, with reference to FIGS. 2 and 3. FIG. 2 is a perspective view of a storage enclosure for housing computing equipment usable within implementations of computing network 100. FIG. 2 shows a storage enclosure 200 housing computer servers, such as one or more of servers 102, 104, 106. One implementation of this structure includes a computer hardware rack or other storage enclosure, frame, or mounting that houses rack mounted servers. In this example, the computer servers include their own power supplies and network connections. Another implementation includes a blade enclosure containing blade servers. The blade enclosure includes power supplies, cooling units, and networking components shared by the constituent blade servers. A control center (not shown) may be included to supervise or manage operations of the racked computer servers.

FIG. 3 is a block diagram of a digital data processing machine or device 300 usable within implementations of computing network 100. Device 300 may be implemented by one or more computing devices such as a mobile telephone, a tablet computer, laptop computer, notebook computer, desktop computer, server computer, mainframe computer, computer workstation, and the like.

In an implementation, device 300 includes CPU 302, memory 304, storage 312, network 306, display 308, and bus 310. One example of CPU 302 is a conventional central processing unit. CPU 302 may include single or multiple processors each having single or multiple processing cores. Alternatively, CPU 302 may include another type of device, or multiple devices, capable of manipulating or processing information now-existing or hereafter developed.

Memory 304 may comprise RAM or any other suitable type of storage device. The memory 304 may include executable instructions and data for immediate access by CPU 302. Memory 304 may include one or more DRAM modules such as DDR SDRAM. Alternatively, memory 304 may include another type of device, or multiple devices, capable of storing data for processing by CPU 302 now-existing or hereafter developed. CPU 302 may access and manipulate data in memory 304 via bus 310.

Storage 312 may include executable instructions 312A and application files 312B along with other data. Executable instructions 312A may include, for example, an operating system and one or more application programs for loading in whole or part into memory 304 and to be executed by CPU 302. The operating system may be, for example, Windows, Mac OS X, Linux, or another operating system suitable to the details of this disclosure. The application programs may include, for example, a web browser, web server, database server, and other such programs. Some examples of application files 312B include client/user files, database catalogs, and configuration information. Storage 312 may comprise one or multiple devices and may utilize one or more types of storage, such as solid state or magnetic.

The internal configuration may also include one or more input/output devices, such as network 306 and display 308. Network 306 and display 308 may be coupled to CPU 302 via bus 310, in one example. Network 306 may, for example, include a network interface and may take the form of a wired network interface such as Ethernet or a wireless network interface. Other output devices that permit a client/user to program or otherwise use the client or server may be included in addition to or as an alternative to display 308. When the output device is or includes a display, the display may be implemented in various ways, including by a LCD, CRT, LED, OLED, etc.

Other implementations of the internal architecture of clients and servers are also possible. For example, servers may omit display 308 as well as client programs such as web browsers. Operations of CPU 302 may be distributed across multiple machines which may be coupled directly or across a local area or other network. Memory 304 and/or storage 312 may be distributed across multiple machines such as network-based memory or memory in multiple machines performing the operations of clients or servers. Although depicted here as a single bus, bus 310 may be composed of multiple buses.

Various instances of digital data storage may be used to provide storage internal and/or external to the components previously described and illustrated. Depending upon its application, such digital data storage may be used for various functions, such as storing data and/or storing machine-readable instructions. These instructions may themselves support various processing functions, or they may serve to install a software program upon a computer, where such software program is thereafter executable to perform other processing functions related to this disclosure.

In any case, the storage media may be implemented by nearly any mechanism to digitally store machine-readable signals. One example is optical storage such as CD-ROM, WORM, DVD, digital optical tape, disk storage, or other optical storage. Another example is direct access storage, such as a conventional “hard drive”, redundant array of inexpensive disks (RAID), or another direct access storage device (DASD). Another example is serial-access storage such as magnetic or optical tape. Still other examples of digital data storage include electronic memory such as ROM, EPROM, flash PROM, EEPROM, memory registers, battery backed-up RAM, etc.

In an implementation, a storage medium is coupled to a processor so the processor may read information from, and write information to, the storage medium. In the alternative, the storage medium may be integral to the processor. In another example, the processor and the storage medium may reside in an ASIC or other integrated circuit.

In contrast to storage media that contain machine-executable instructions, as described above, a different embodiment uses logic circuitry to implement some or all of the processing features described herein. Depending upon the particular requirements of the application in the areas of speed, expense, tooling costs, and the like, this logic may be implemented by constructing an application-specific integrated circuit (ASIC) having thousands of integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, transistors, and the like), field programmable gate array (FPGA), programmable logic array (PLA), programmable logic device (PLD), and the like.

More particularly, one or more clients or servers or other machines described herein may include an ASIC or programmable logic array such as a FPGA configured as a special-purpose processor to perform one or more of the operations or steps described or claimed herein. An exemplary FPGA may include a collection of logic blocks and RAM blocks that may be individually configured and/or configurably interconnected in order to cause the FPGA to perform certain functions. Certain FPGAs may contain other general or special purpose blocks as well. An exemplary FPGA may be programmed based on a hardware definition language (HDL) design, such as VHSIC Hardware Description Language or Verilog.

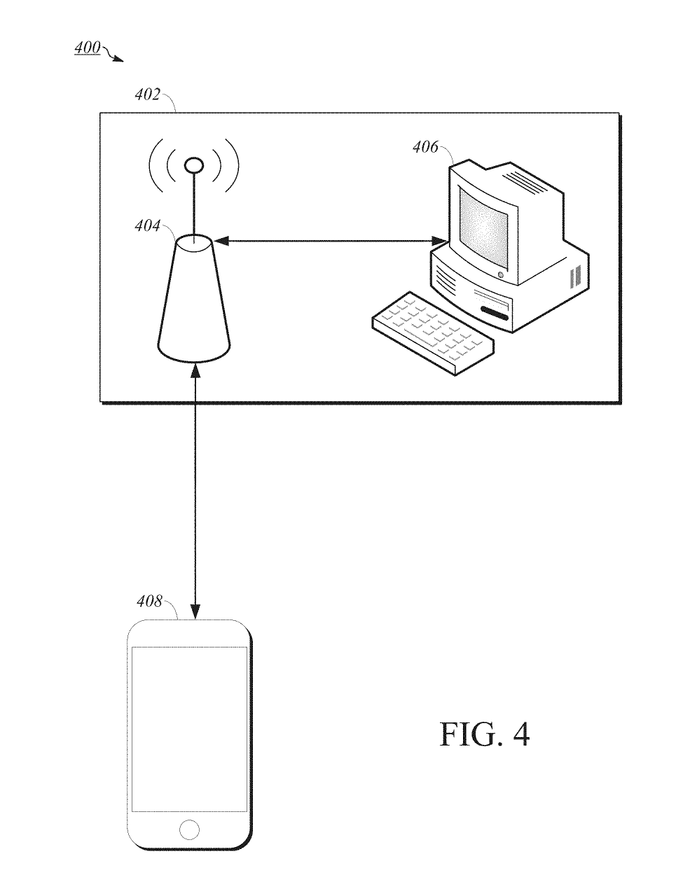

Certain operational aspects of the disclosure will now be described with reference to FIGS. 4 through 6. FIG. 4 is a diagram 400 showing data being communicated between an example user device 408 and an example proximity detection system 402. In an implementation, proximity detection system 402 comprises detector 404 and computing system 406. In an implementation, proximity detection system comprises a single device for detecting other devices and processing data communicated thereby. Proximity detection system 402 can be located entirely within a single physical location, for example, a physical store, or within multiple physical locations, for example, where detector 404 is located at a physical store and computing system 406 is located in a data center or other facility.

Detector 404 can be a device for detecting other devices, for example, those within a near proximity of detector 404. In an implementation, detector 404 comprises a wireless network router and a controller, including a transceiver for communicating data received by a first device (e.g., user device 408) to a second device (e.g., computing system 406). In an implementation, the transceiver comprises a sensor for detecting devices in communication with detector 404. The sensor can be used to detect a signal communicated by user device 408, such as a probe transmitted for identifying communication systems for connecting to a computing network, or an indication that user device 408 has connected to a communication system associated with detector 404. The sensor may also or instead be used to monitor a physical condition of a component usable with a computing network to which detector 404 is connected, for example, by measuring a temperature of a CPU, memory, or storage for a server associated with detector 404. In an implementation, the detector can be a network device (e.g., a router), an integrated special purpose device, a system comprising a network routing device and a server, or any other suitable device for recognizing data communicable by a first device to a second device. In an implementation, data communicated by user device 408 to computing system 406 is not communicated through detector 404; rather, detector 404 can be used to validate or authenticate user device 408 in order to allow for the direct or indirect communication between user device 408 and computing system 406.

Although detector 404 is above described as a device for detecting other devices within a near proximity of detector 404, the detection of such other devices may be limited or improved based on a power of detector 404. Thus, proximity can depend upon the implementation and power of detector 404. For example, where detector 404 is very powerful, it may be configured to detect such other devices within a city block or larger region. However, where detector 404 is minimally powerful, it may only be configured to detect such other devices within a specific room of a physical store, or, if possible, the physical store and adjoining parking or walking areas, as applicable.

Computing system 406 can be a computer or group of computers for processing data communicated by user device 408. For example, computing system 406 can be used to identify data communicated by or from user device 408 to determine whether user device 408 has been used to view electronic records related to a commercial entity associated with proximity detection system 402. In an implementation, computing system 406 comprises software for customer relationship management for customers of the commercial entity. In an implementation, computing system 406 comprises or is configured to communicate data received from user device 408 to one or more analytics systems for aggregating, analyzing, and otherwise processing the data received from user device 408. In an implementation, computing system 406 is comprised on a same device as detector 404. In an implementation, computing system 406 and detector 404 comprise separate devices.

User device 408 can be a device for use by one or more people and can be a client computer, such as one of clients 108, 110, 112 of FIG. 1. In an implementation, user device 408 is an Internet-enabled mobile device. References throughout this disclosure may describe or otherwise refer to user device 408 as a smartphone, however any other type of device, whether explicitly, implicitly, or not described in this disclosure, can be user device 408. For example, in an implementation, user device 408 can be a vehicle driven by a user. User device 408 is associated with one or more people, or users, based at least in part on the user(s) carrying user device 408 or otherwise having access to it. References throughout this disclosure may describe or otherwise refer to user device 408 as being associated with a single user having registered a profile or account or otherwise being the primary user of user device 408, however any other type of user, whether explicitly, implicitly, or not described in this disclosure, can be the user associated with user device 408.

Diagram 400 depicts a general flow of data between user device 408, detector 404, and computing system 406. In an implementation, before data may be communicated by or from user device 408, user device 408 may first be required to connect to a network associated with proximity detection system 402. In an implementation, such as where detector 404 comprises a network router, connecting to the network may include the user device 408 becoming connected to the network using a service set identifier (SSID) associated therewith. In an implementation, detector 404 may be able to detect user device 408 without user device 408 being required to connect to any network associated with detector 404, for example, by leveraging a connection with a different communication system usable by user device 408. In an implementation, and as will be discussed below in greater detail, communication between user device 408 and proximity detection system 402 can be established in other ways, for example, by detector 404 detecting data indicative of a location of user device 408 communicated by or in connection with a software application executed on user device 408.

In an implementation, data may be communicated from detector 404 to user device 408, for example, to indicate that detector 404 has received data from user device 408 or that user device 408 has successfully connected to a network associated with detector 404. Similarly, in an implementation, data may be communicated from computing system 406 to detector 404, for example, to indicate that computing system 406 has received data from user device 408 or detector 404 or that data indicative of a network associated with detector 404 has been changed in some way.

In an implementation, proximity detection system 402 can be used to identify electronic records previously viewed on, by, or otherwise in connection with user device 408 prior to user device 408 being detected, for example, within a near proximity of a physical location. For example, where the physical location is a physical store of a particular commercial entity, upon detector 404 detecting user device 408, computing system 406 can determine whether user device 408 has been previously used to view online content, such as websites, advertisements, etc., associated with the commercial entity. Data indicative of this previous viewing may be communicated, passively or actively, and directly or indirectly, by or from user device 408 to computing system 406. Computing system 406 can process the data to determine that the electronic records previously viewed using user device 408 pertain to the commercial entity. For example, computing system 406 may identify cookies, metadata, or other computer code or instructions indicative of user device 408 having browsed to a website, which may be a first-party website of the commercial entity on which it describes its goods or services, or a third-party website on which those goods or services are described, for example, through an advertisement.

In an implementation, computing system 406 can determine whether an electronic record on which online content associated with the commercial entity appears has been partially viewed using user device 408. For example, computing system 406 can identify situations where user device 408 was used to view a website on which an online advertisement of the commercial entity is located, but where data indicative of the online advertisement was not output on a display of user device 408, such as where the user of user device 408 did not browse to a location of the website where the online advertisement was located. In an implementation, determining such partial viewing of electronic records can be done by identifying data indicative of partial viewership from trace log data stored, for example, in a database on user device 408 or a server on which the corresponding website is operated.

In an implementation, computing system 406 may compare the data from user device 408 to data known to be associated with various first- and third-party websites related to the commercial entity (e.g., by matching the source of the data communicated by or from user device 408 to that of the first- or third-party website). In this way, proximity detection system 402 can assist a commercial entity in understanding whether a customer (e.g., a user of user device 408) is present in the physical store because of something he or she previously viewed online. Proximity detection system 402 can further identify trends in viewership to determine the effectiveness of various electronic records, for example, based on the sources associated with the most frequently identified electronic record viewing data.

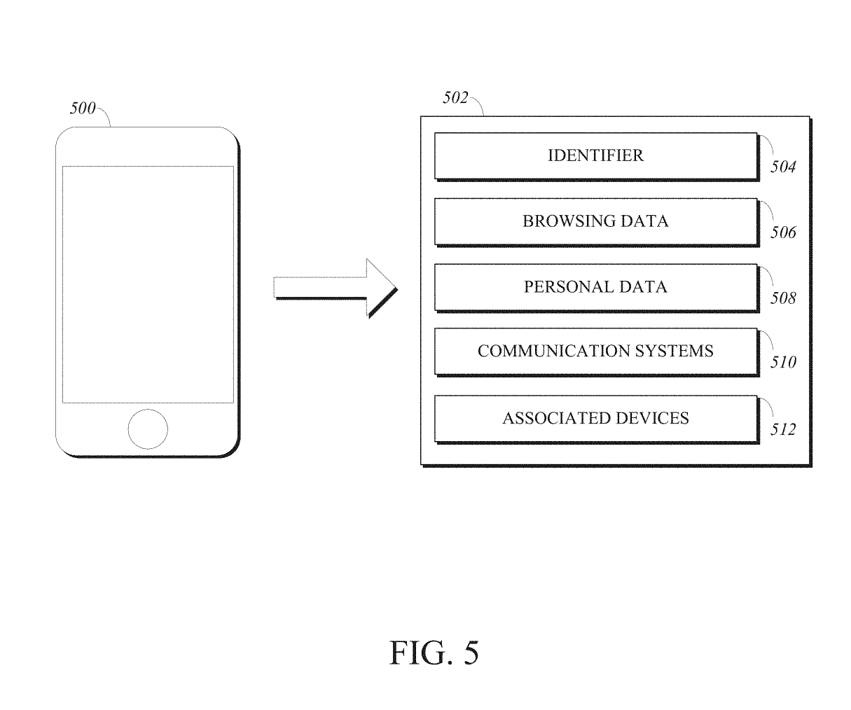

FIG. 5 is a diagram of example data associated with an example user device usable within implementations of the present disclosure. As discussed above, device 500 represents a user device, such as an Internet-enabled mobile device, which can be connected as a client to computing network 100. Data 502 can include any data useful for identifying device 500 (e.g., over link 114 of computing network 100) and determining electronic records previously viewed on, by, or otherwise in connection with device 500. In an implementation, data 502 comprises identifier 504, browsing data 506, personal data 508, communication systems 510, and associated devices 512.

Identifier 504 can be an identifier representative of and/or associated with user device 500. In an implementation, identifier 504 can be a unique identification, such as a media access control (MAC) address or device fingerprinting code, for identifying the device. In an implementation, identifier 504 can be an identifier shared by multiple devices (e.g., as part of a group or collection of devices, such as devices belonging to a company or school), for example, wherein the identifier identifies user device 500 as part of a group or collection, such as where the identifier is associated with the group or collection of devices in a database. A second identifier may be included in that or other implementations for specifying user device 500 from amongst multiple devices, for example, wherein the first identifier comprises an identification code indicative of user device 500 being part of a group or collection and the second identifier comprises a MAC address of user device 500.

In an implementation, identifier 504 is representative of user device 500 as well as a user associated with user device 500. For example, where multiple users use user device 500 (e.g., where it is detected that user device 500 includes multiple registered profiles or accounts), identifier 504 may be paired to user device 500 and a particular user profile or account. In an implementation, a first identifier may be used to identify user device 500 and a second identifier for identifying the particular user. In an implementation, identifier 504 comprises a promotional code particular to a user registered with an online portal of a commercial entity. Regardless of the particular implementation, identifier 504 provides a way for a proximity detection system to identify user device 500 as being user device 500 and not some other device connected over an associated communication system.

Browsing data 506 can be any data indicative of a user's online browsing history, habits, viewership, interactions, etc. In an implementation, browsing data is indicative of electronic records previously viewed on user device 500. Electronic records include first-party websites, third-party websites (e.g., those including online advertisements associated with a commercial entity), online advertisements generally, media (e.g., pictures, sound files, videos, games, etc.), or any other type of electronic communication, whether text, video, graphic, sound, or any combination of the foregoing, and whether commercial, entertainment-based, academic, governmental, or otherwise. In an implementation, an electronic record can comprise an online advertisement or other communication or only a portion of an online advertisement or other communication. In an implementation, an electronic record can be a static or dynamic record generated or otherwise selected by user device 500 or a source of the electronic record. In an implementation, an electronic record can be an interactive record with a user of user device 500. In an implementation, the electronic record can be pushed or pulled onto user device 500 by or from the source of the electronic record.

Personal data 508, also referred to as personal information, can be any data indicative of a user of user device 500. For example, personal data 508 can include any information that may or may not be publicly available about the user himself or herself, such as his or her name, mailing address, shipping address, zip code, email address, employer, trade or industry, website usernames, favorite websites, past purchases, billing history, credit card information, etc. In an implementation, personal data 508 can be included as part of browsing data 506, for example, as part of or in association with an electronic record. In an implementation, personal data 508 can be used to fill in gaps in browsing data 506, for example, by identifying information about the user's Internet browsing habits not already indicated by browsing data 506.

Communication systems 510 can be data indicative of communication systems available for use or actively used by device 500. Any type of communication system can be usable with the present disclosure, including, without limitation, Internet, intranet, Ethernet, WiFi, Bluetooth, radio frequency, near field communication (NFC), code division multiple access (CDMA), global system for mobile communications (GSM), long-term evolution (LTE), or any other suitable communication system. In an implementation, communication systems 510 comprises data indicative of a wireless network on which device 500 is in communication with a proximity detection system, such as proximity detection system 402 of FIG. 4. Communication systems 510 can be limited by the hardware configurations particular to device 500, which, in an implementation, can be extended by the addition of further components. For example, components for boosting or improving a communication signal identifiable by device 500 may be added thereto, or components for introducing a communication system not previously known to device 500 may be added, such as where new frequencies for wireless communication are conceived.

Associated devices 512 can be data indicative of other devices associated with the user of user device 500 or associated with user device 500 irrespective of the particular user. For example, associated devices 512 can comprise data indicative of other electronic devices owned by the user of user device 500, other electronic devices from which the user has been identified as an online customer of the commercial entity, electronic devices included within a group or collection of devices of which user device 500 is included, etc. In an implementation, data indicative of electronic records previously viewed on associated devices 512 can be identified based on an association with user device 500. In an implementation, data indicative of associated devices 512 can further be used to provide further sales opportunities after the user of user device 500 has left the physical store. For example, the commercial entity may communicate offers related to the user's offline traffic and/or sales to associated devices 512 for future online and/or offline sales opportunities.

Although data 502 is illustrated as being associated with device 500, data 502 may be associated with any device, machine, or client within computing network 100. While data 502 is shown as including data items 504, 506, 508, 510, and 512, other data elements not shown or herein disclosed may also be associated with a device. For example, in an implementation, data 502 may further comprise metadata indicative of past viewing of electronic records on device 500, data indicative of probing activities of device 500 (e.g., for communicating data between device 500 and another device, such as detector 402 of FIG. 4), data indicative of a user of device 500 beyond personal data 508, etc. Similarly, it may be the case that the data associated with a device of computing network 100 does not include one or more of the data items shown or that it includes data elements not shown and exclude data elements that are shown. However, each device usable within computing network 100 has associated therewith at least some data elements.

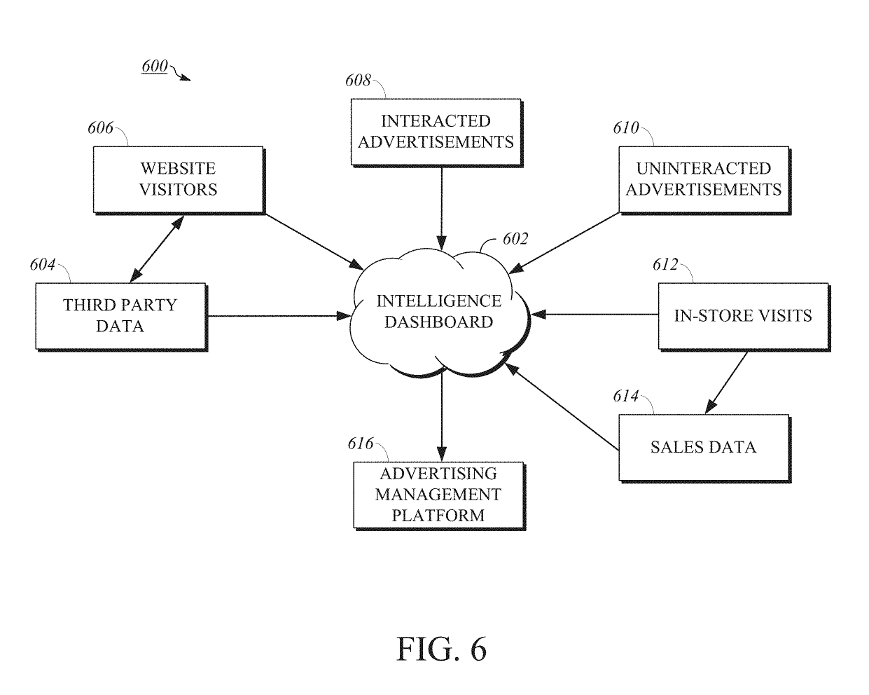

Data related to an Internet user's viewership and/or interactions with electronic records can be uploaded or otherwise communicated to and thereafter maintained, monitored, and otherwise analyzed by a central system, such as an intelligence dashboard. FIG. 6 is a block diagram 600 of an example intelligence dashboard 602 usable within implementations of the present disclosure. Intelligence dashboard 602 provides an opportunity for commercial entities to evaluate advertising campaigns and electronic records generally associated with them to identify effectiveness, for example, based on customer trends. In an implementation, intelligence dashboard 602 is a cloud-based system for tracking offline customer traffic and/or sales and correlating data indicative of same with online behavior. In an implementation, intelligence dashboard 602 comprises instructions executed on a server, such as one of servers 102, 104, 106 of FIG. 1. In an implementation, intelligence dashboard uses and processes information based on third party data 604, website visitors 606, interacted advertisements 608, uninteracted advertisements 610, in-store visits 612, sales data 614, and advertising management platform 616.

Initial data for identifying viewership and interaction of electronic records may be derived from third party data 604 and website visitors 606. In an implementation, third party data 604 comprises information unrelated to goods or services offered by a commercial entity, but which could have an effect on supply, demand, pricing, or some other aspect of commerce. For example, third party data may include an indication of upcoming holidays, weather events, material changes in gasoline prices, unavailability of resources, etc. In an implementation, third party data could also or instead include information that may be related to the commercial entity's goods or services. For example, where the commercial entity deals in automobile insurance, inventory data received from a third party automobile trader may be useful for deciding advertising campaigns to introduce online. Similarly, in an implementation, third party data 604 can have a direct effect on advertisements associated with intelligence dashboard 602. For example, where certain goods sold by the commercial entity are provided from a particular third party and third party data 604 indicates that such third party is out of stock of those goods, third party data 604 can be used to cease advertising those goods until the stock is replenished.

Website visitors 606 can be data indicative of the persons who visit websites related to the commercial entity, for example, the entity's own first-party websites, third-party websites related to the goods or services of the entity (e.g., a competitor's website), third-party websites unrelated to those goods or services that include some association with the commercial entity (e.g., by including an advertisement, content, or other electronic record for the commercial entity), etc. In an implementation, website visitors 606 can include data indicative of third party data 604, for example, where persons visiting the websites had previously viewed online content related to third party data 604.

Interacted advertisements 604 includes data indicative of any electronic records that have been interacted with by a user. In an implementation, interaction as used in the preceding sentence refers to any action taken with respect to the electronic record beyond merely viewing it, for example, clicking on or otherwise selecting an electronic record (e.g., to navigate between pages of a first-party website, to load a new website from an advertisement, banner, or other electronic record related to a third-party website, to cause some change to occur with respect to the electronic record, etc.). In contrast, uninteracted advertisements 606 includes data indicative of any instance of viewing an electronic record not considered as interacted advertisements 604. For example, where a user is merely browsing a website that happens to have an advertisement for a commercial entity located thereon but does not click on or otherwise select the advertisement, the advertisement can be considered an uninteracted advertisement. In an implementation, uninteracted advertisements 606 can include data indicative of electronic records partially viewed using the user device, for example, where online content associated with a commercial entity appearing on an electronic record was not output to display on the user device although other aspects of the electronic record were so output.

In-store visits 612 includes data indicative of a visit to a physical store by a user who had previously viewed an electronic record. In an implementation, the determination that the user had previously viewed an electronic record can be made based on one or more of third party data 604, website visitors 606, interacted advertisements 608, or uninteracted advertisements 610. In an implementation, in-store visits indicate certain data to intelligence dashboard for use in updating or otherwise monitoring advertising campaigns and other electronic records, including without limitation information about which in-store customer has viewed which first- or third-party website, whether or not an in-store customer interacted with an advertisement or merely viewed it, and whether any third-party websites or information lead the customer to the commercial entity. In an implementation, data indicative of in-store visits 612 can be communicated from a user device of a customer physically present in a physical store, for example, by receiving data from the user device over a communication system, such as WiFi, Bluetooth, etc. In an implementation, data indicative of in-store visits 612 may be used to further identify sales data 614, for example, where a customer in a physical store who had previously viewed an electronic record completes a sales transaction. Sales data 614 can include information about the goods or services purchased, including make, model, quantity, date, and any other relevant characteristics. Thus, in-store visits 612 (and sales data 614) can be indicative of the effectiveness of online advertisements attributed to offline traffic and/or sales.

In an implementation, in-store visits 612 may further detail aspects of a customer's visit to a physical store. For example, in-store visits may comprise data representative of a duration of time that the customer spent visiting the physical store, whether it was the customer's first time in the store, a date of last visit (to the extent applicable), a time at which the customer arrived at the store, and locations in the store that the customer perused. In an implementation, in-store visits 612 may be used to track multiple customers at once to identify a total number of customers present in the physical store at a given time.

Advertising management platform 616 can receive data from intelligence dashboard 602 to manage and update advertising campaigns and other electronic records based on the data collected, maintained, and monitored in diagram 600. For example, the data can be used to identify campaigns that did not reach targets, customers who were exposed to advertising but did not enter a physical store in response to the exposure, and determine the effectiveness or advertisements based in part on their frequency and placement. In an implementation, advertising management platform 616 comprises a recommendation engine and a media mix updater. The recommendation engine can be used to make changes to advertising campaigns and electronic records generally based on the data processed through intelligence dashboard 602. The media mix updater can be used to communicate these changes to first- and third-party websites to effect the changes. The media mix updater may comprise scripts and other programmable instructions for interacting with third-party websites, for example, to request changes to advertisements or other content located thereon. In an implementation, the media mix updater can be included as part of the recommendation engine or vice versa.

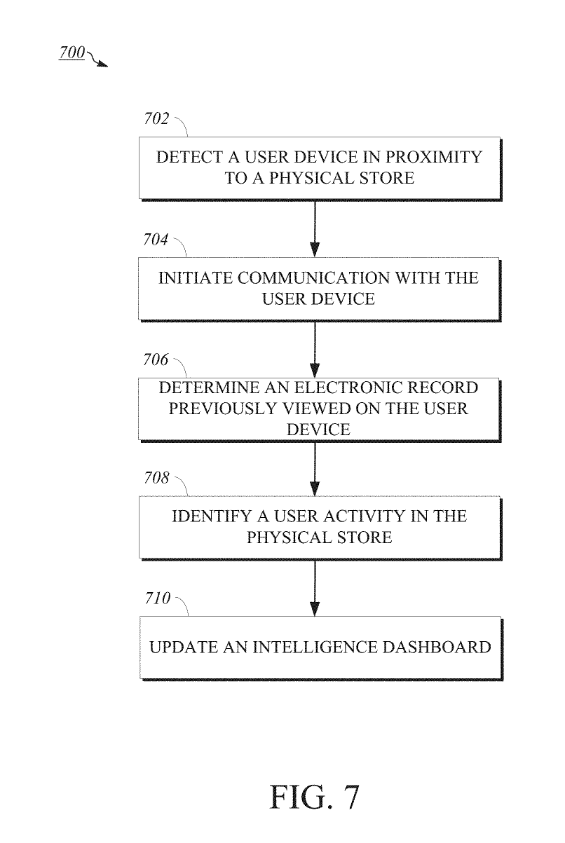

Further implementations of the disclosure will now be described with reference to FIG. 7. The steps, or operations, of any method, process, or algorithm described in connection with the embodiments disclosed herein may be embodied directly in hardware, firmware, software executed by hardware, circuitry, or a combination of these. Broadly, method 700 of FIG. 7 can be used to perform certain monitoring and analysis in computing network 100. In an implementation, method 700 may be performed using machines and hardware such as the equipment of FIGS. 1 through 5. Method 700 may be performed, for example, by executing a machine-readable program of JavaScript, C, or other such instructions. Implementations of the present disclosure may include multiple of the above-described features.

For ease of explanation, method 700 is depicted and described as a series of operations. However, operations in accordance with this disclosure may occur in various orders and/or concurrently. Additionally, operations in accordance with this disclosure may occur with other operations not presented and described herein. Furthermore, not all illustrated operations may be required to implement a method in accordance with the disclosed subject matter.

FIG. 7 is a flowchart showing an example method 700 for using an implementation of the present disclosure for detecting a physical presence of a device used to view an electronic record. At operation 702, a user device is detected in proximity to a detector. In an implementation, the user device is detected in proximity to a physical store wherein the detector is located. In an implementation, detection of the user device occurs in response to the user device emitting a signal or probe searching for a connection to a communication system, such as WiFi, Bluetooth, etc. For example, the user device may broadcast a ping or probe (e.g., one time, continuously, periodically, non-periodically, or otherwise) during regular operation, wherein, upon being detected within a sufficient proximity from the detector, the probe initializes a connection to a network associated with the detector.

In an implementation, the physical presence of the user device used to view an electronic record is detectable without requiring any software to be installed beyond what is necessary for accessing the Internet on the device. For example, where the device is an Internet-enabled mobile device, the present disclosure does not require that a mobile application for detecting the mobile device by a sensor be first installed. Rather, features already present on a typical mobile device can be used to communicate the data necessary for the operation of implementations of the present disclosure. In an implementation, a user is not required to take any active action to prepare the device for detection by the sensor. For example, the user need not select any options to configure the device for detection or otherwise opt-in to participate in detection. However, the probe can only be broadcast (and the user device detected) when communication channels are open on the user device. For example, to detect the user device over a WiFi network, the user device must have WiFi enabled.

In an implementation, the location of the user device can be detected irrespective of a WiFi connection operated at a computing device within a physical location. For example, the computing device can receive location data communicated by or from the user device indicative of a latitude and longitude coordinate of the user device. In an implementation, the location data can be communicated by or from a software application passively or actively executed on the user device. In an implementation, the location data can be communicated by or from a geolocation component of the user device, such as a global positioning system (GPS) chip integrated within the user device, or from a navigation application utilizing such geolocation component. In an implementation, the location data can be communicated based on a user response to an operating system request for location information, for example, as part of a request made via an application program interface (API) of the operation system executed on the user device, for example, for an external device (e.g., the computing device in the physical location, etc.) to obtain location information of the user device. In an implementation, for example, where a software application operated in connection with the computing device or a server in communication with the computing device is installed on the user device, the location data can be communicated in response to the user responding to a location request of the software application API (e.g., requesting that the user opt-in to sharing the location data). In an implementation, the location data can be obtained from cellular carrier towers, for example, by triangulating signals indicative of a location of the user device. In an implementation, the location data communicated per the foregoing or other implementations can be stored in a database operated in connection with the proximity detection system, for example, to maintain location data of the user for future use.

In an implementation, detecting the user device comprises identifying an identifier representative of the device. The identifier may be used later on, for example, to determine electronic records previously viewed on the user device.

At operation 704, communication is initiated with the user device, for example, by the detector or a computing system in communication with the detector. In an implementation wherein the detector is a network device, such as a router, the detector may communicate data representative of the network back to the user device in response to receiving the probe. For example, the detector may indicate an SSID representative of the network for the user device to join. The network may not require that a password or active authentication be entered or performed; rather, in an implementation, connection to the network is passive. In an implementation, communication between the device and the detector is enabled in response to the identification of the identifier of the device.

At operation 706, one or more electronic records previously viewed on the user device is determined, for example, based on browsing data communicated by or otherwise received from the user device. In an implementation determining the electronic records is done based on tracking information, such as cookies, included in connection with online advertisements or websites. For example, any cookies or other tracking information may be probed to identify a list of online advertisements or websites (or other electronic records) that have previously been viewed on or by the user device. In an implementation, determining the electronic records is done based on the identifier of the device. For example, the identifier can be compared against a list of identifiers maintained by a database or other store of an online advertising network to determine a number of times that the user device has viewed an electronic record and a list of electronic records that have been viewed by the user device. Thus, it can be determined by this comparison whether electronic records associated with the commercial entity operating the physical store in which the device is detected have been viewed on the device prior to detection.

This system can be used to determine whether the user device has viewed first-party or third-party websites, online advertisements on third-party (or other) websites, other online content, etc. associated with the commercial entity. In an implementation, a degree to which the electronic record made an impression on the user may be discernable based on whether the user interacted with an electronic record. For example, where the electronic record is an online advertisement, it can be determined whether the user clicked on or otherwise selected the advertisement or merely viewed it without interaction.

Other information can be determined from the browsing data. For example, persons who did not view an electronic record, but who had opportunity to, based on viewing records, may be indicated to understand the extent to which an advertising campaign including the electronic record failed to reach the person. Also, a total number of people present in the physical store who previously viewed a particular electronic record can be determined in order to assess the efficacy thereof, for example, regardless of whether or not those people did not interact with the electronic record (e.g., by clicking on it or otherwise selecting it) or based further on whether not they so interacted.

Implementations of the present disclosure may not require that a user enter personal information when viewing the electronic record using the user device. For example, in an implementation wherein the device is a mobile device and the electronic record is a first-party website of an advertiser, the user does not need to enter personal information (e.g., name, credit card number, shipping address, etc.) on the website in order for the present disclosure to be able to identify him or her; rather, an identifier of the mobile device, such as a MAC address, associated with the user can be used to identify the user using implementations of the present disclosure. Notwithstanding the foregoing, in an implementation, the present disclosure may supplement the identifier of the device with personal information entered by a user to validate an identity of the user. For example, the identifier of the user device may be used to identify the user and the personal information entered by the user can be used to validate it.

In an implementation, determining prior viewership or interaction with an electronic record may further comprise determining whether the electronic record was viewed or interacted with on a second device associated with the user device. The association between the user device and the second device may be based on a determination that one or more accounts registered on the user device are also registered on the second device, that personal data representative of the user of the user device matches that of the second device, that the same account has been utilized (e.g., by the user logging into an email account) on each of the user device and the second device, or any other suitable manner for determining the association. In an implementation, the user device can be correlated to one or more second devices based on the identifier of the user device. For example, the user may be asked to opt-in to an offer or program delivered using a messaging service that records the identifier of each device to which the messages are sent.

At operation 708, a user activity occurring within the physical store is identified. The user activity can be any activity related to the customer traffic and/or offer for purchase of goods or services by or in connection with the user of the user device. For example, user activity may be identified to determine the goods displayed for sale that the user has looked at for a prolonged period of time. In an implementation, the detector can identify movement of the device within a near proximity of the detector. For example, the detector can determine that the device is moving based on a strength of a signal communicated by the device or by the detector (e.g., using an association with a SSID). Alternatively, user activity may be indicative of a completed transaction for the purchase of those goods. In an implementation, data indicative of whether a customer made a purchase while present in a physical store can include electronic data derived from electronic coupons (e.g., those communicated to an email address associated with the customer), online payments made by the customer (e.g., as determined based on personal data used at the time of payment), quick response (QR) codes communicated to the customer and indicative of the customer (e.g., as including personal data about the customer in the code), data scanned by in-store scanners, or data received from a point-of-sales or other payment application (e.g., whether an in-store feature or as a mobile application interfacing therewith). By identifying completed transactions made by users who had previously viewed an electronic record for the commercial entity, correlations can be made to determine positive efficacy of advertising campaigns (e.g., to identify a positive return on investment relative to a campaign).

At operation 710, an intelligence dashboard (e.g., intelligence dashboard 602 of FIG. 6) can be updated to reflect data indicative of one or more of the user device being detected in the physical store, the occurrence of a user activity within the physical store, or any other useful information identified (e.g., by proximity detection system 402 of FIG. 4). In an implementation, this update data can be used to base further marketing and advertisement decisions. In an implementation, this update data can be aggregated with previously known or stored intelligence data to update statistics about advertising efficacy. In an implementation, this update data can be used to better understand an individual customer's online and offline browsing behaviors, goods or services of interest, etc.

In an implementation, the intelligence dashboard may maintain records indicative of online and offline behaviors of monitored customers. For example, various aspects of customer behavior can be analyzed based on previously viewed electronic records and offline user activities in-store, such as overall in-store customer traffic based on electronic records (e.g., by the hour, day, week, month, etc.), real time in-store customer numbers, temporal durations during which user devices were detected (e.g., by total, average, etc.), whether the customers were new or returning customers, the communication systems most used for detecting customers in-store, and so on. Personal information about the customers may also be gathered, for example, gender, age, number of times having visited the physical store (and/or online store component, to the extent applicable), contact information, preferred messaging types, and so on. Other aspects of customer behavior may be analyzed as desired, such as the names or total number of people who previously viewed an electronic record but left the physical store too quickly for a transaction to be completed.

In an implementation, the data updated to and maintained by the intelligence dashboard can be used to assess the value and effectiveness of a media mix of electronic records (e.g., the specific arrangement, location, frequency, etc., of online advertisements on first- and third-party websites). That is, the effectiveness of an electronic record can be determined based on user activity online and offline. For example, based on data identified using method 700, it can be determined whether a customer was ever exposed to an online advertisement related to a commercial entity. If the customer interacted with the online advertisement, that information is denoted, as is information indicating that the customer declined to interact with it. The intelligence dashboard may keep track of instances wherein a customer visited the commercial entity's first-party website in response to viewing an online advertisement, interacting with an online advertisement, and/or visiting a third-party website first.

Accordingly, implementations of the present disclosure provide meaningful ways to measure the effectiveness of online advertisements based on offline traffic and/or sales attributions, and further to make changes to an online advertising campaign based on customer data identified for online and/or offline behaviors. In this way, advertisers, such as commercial entities, can identify what electronic records carry influence over affecting offline customer traffic and/or sales. Further, information about an in-store customer's browsing data can be leveraged while the customer is still browsing goods or services for sale at the physical store. In this way, the commercial entity operating the store may have a greater opportunity for business with the customer based at least in part on its understanding of the customer's online behaviors.

While the foregoing disclosure shows a number of illustrative embodiments, it will be apparent to those skilled in the art that various changes and modifications can be made herein without departing from the scope of the disclosure as defined by the appended claims. Accordingly, the disclosed implementations are representative of the subject matter which is broadly contemplated by the present disclosure, and the scope of the present disclosure fully encompasses other embodiments which may become obvious to those skilled in the art, and that the scope of the present disclosure is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

Furthermore, although elements of the disclosure may be described or claimed in the singular, reference to an element in the singular is not intended to mean “one and only one” unless explicitly so stated, but shall mean “one or more.” Additionally, ordinarily skilled artisans will recognize in view of the present disclosure that while operational sequences must be set forth in some specific order for the purpose of explanation and claiming, the present disclosure contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The foregoing description describes only some examples of implementations of the described techniques. Other implementations are available. For example, the particular naming of the components, capitalization of terms, the attributes, data structures, or any other programming or structural aspect is not mandatory or significant, and the mechanisms that implement the systems and methods described herein or their features may have different names, formats, or protocols. Further, the system may be implemented via a combination of hardware and software, as described, or entirely in hardware elements. Also, the particular division of functionality between the various system components described herein is merely by example, and not mandatory; functions performed by a single system component may instead be performed by multiple components, and functions performed by multiple components may instead performed by a single component.

It is to be understood that the present disclosure is not to be limited to the disclosed implementations but, on the contrary, is intended to cover various modifications and equivalent arrangements included within the scope of the appended claims.

What is claimed is:

1. A proximity detection system for detecting a physical presence of a device previously used to view an electronic record, comprising:
a detector comprising a processor and a sensor coupled to the processor, the detector configured to detect a physical presence of a first device in proximity to the sensor, wherein the first device is associated with a user, and to establish, without intervention, communication with the first device upon detection; and
a computing system in communication with the detector, the computing system configured to receive an identifier and browsing data communicated by the first device and identify data indicative of a prior communication of the electronic record to at least one of the first device and a second device.

2. The proximity detection system of claim 1, wherein the detector is further configured to determine a temporal duration for which the first device is detected in proximity to the sensor.

3. The proximity detection system of claim 1, wherein the computing system is further configured to determine the electronic record by comparing the browsing data to electronic record data associated with the computing system.

4. The proximity detection system of claim 1, wherein the electronic record comprises one of a first-party website of a commercial entity or an advertisement of a commercial entity on a third-party website.

5. The proximity detection system of claim 1, wherein at least one of the first device or the second device comprises an Internet-enabled mobile device.

6. The proximity detection system of claim 1, wherein the identifier comprises a MAC address.

7. The proximity detection system of claim 1, wherein the computing system is further configured to communicate data indicative of the physical presence of the first device being in proximity to the sensor to an intelligence dashboard.

8. The proximity detection system of claim 1, wherein the detector is configured to detect the physical presence of the first device by:
detecting location data indicative of a location of the first device relative to a location of the sensor.

9. A method for detecting a physical presence of a device previously used to view an electronic record, comprising:
detecting, by a sensor, a first device in proximity to the sensor, the first device having an identifier associated therewith;
initiating communication between the first device and a network associated with the sensor;
determining, by a computing system operable on the network, an electronic record previously communicated to one of the first device and a second device; and
identifying a commercial activity performed in proximity to the sensor by a user associated with the first device.

10. The method of claim 9, further comprising:
updating, by the computing system, an intelligence dashboard in response to one of determining the electronic record or identifying the commercial activity.

11. The method of claim 9, further comprising:
determining a temporal duration for which the first device is detected in proximity to the sensor.

12. The method of claim 9, wherein determining the electronic record comprises:
identifying browsing data communicated by one of the first device or the second device, wherein the second device is associated with the first device;
comparing the browsing data to electronic record data associated with the computing system; and
determining the electronic record based on the identifier in response to comparing the browsing data to the electronic record data.

13. The method of claim 9, wherein the electronic record comprises one of a first-party website of a commercial entity or an advertisement of a commercial entity on a third-party website.

14. The method of claim 9, wherein at least one of the first device or the second device comprises an Internet-enabled mobile device.

15. The method of claim 9, wherein the identifier comprises a MAC address.

16. The method of claim 9, wherein the sensor is configured to detect the physical presence of the first device by:
detecting location data indicative of a location of the first device relative to a location of the sensor.

17. A computer program product implemented on a non-transitory storage medium for an intelligence dashboard configured to monitor and analyze data indicative of communications of electronic records comprising a program module having instructions configured to:
identify browsing data communicated by one of a first device to which an identifier is associated and a second device associated with the first device;
identify in-store data based on the identifier;
generate intelligence data based on the browsing data and the in-store data; and
analyze an efficacy of one or more online advertisements based on the intelligence data.

18. The computer program product of claim 17, further comprising:
updating the one or more online advertisements in response to the intelligence dashboard recommending a change based on the intelligence data.

19. The computer program product of claim 17, wherein identifying the browsing data comprises:
receiving data indicative of the first device being used to view one or more of third party data, website data, or advertisement data based on an association between the data and the identifier; and
identifying the browsing data based on the data.

20. The computer program product of claim 17, wherein the in-store data comprises one or more of first data generated based on one of the first device or the second device being detected within proximity to a sensor located in a physical store or second data indicative of a transaction performed at the physical store.
